(19) United States
(12) Patent Application Publication
(10) Pub. No.: US 2002/0113559 A1
(43) Pub. Date: Aug. 22, 2002

(54) Electronic ballast

(76) Inventor: Duong Ba Lam, El Monte, CA (US)

Correspondence Address: CHRISTIE, PARKER & HALE, LLP, P.O. BOX 7068, PASADENA, CA, 91109-7068, US

(21) Appl. No.: 10/061,017

(22) Filed: Jan. 28, 2002

Related U.S. Application Data
(60) Provisional application No. 60/264,810, filed on Jan. 26, 2001.

(51) Int. Cl. H05B 37/02

(52) U.S. Cl. 315/224; 315/276

(57) ABSTRACT

A ballast to control one or more fluorescent lamps by monitoring voltage and regulating current to adjust voltage being supplied to the lamps. The ballast maintains constant power to the lamps and also detects and adjusts for arcing conditions and internally accommodates wiring for one or more lamps.

### CROSS-REFERENCE TO RELATED APPLICATIONS

This application claims the benefit of U.S. Provisional Application No. 60/264,810 entitled Electronic Ballast, filed Jan. 26, 2001, the disclosure of which is hereby incorporated by reference as if set forth herein in full.

### BACKGROUND OF THE INVENTION

The present invention relates to electronic ballasts for aircraft lighting systems, and in particular, to methods and systems that control aircraft fluorescent lamps and provide arc protection.

Fluorescent lamps are widely used in aircraft lighting systems. Fluorescent lamps are manufactured with different wattage and voltage ratings. Fluorescent lamps generate visible light largely by converting ultraviolet energy from a mercury arc. Typically, fluorescent lamps include a glass tube with two electrodes. The electrodes are connected to an external circuit or ballast. The ballast passes current through the tube and when sufficient current and voltage is supplied, an internal arc is initiated. The mercury vaporizes in the internal arc and produces ultraviolet radiation to cause visible light to be emitted.

In order for the internal arc to be initiated, the ballast provides the sufficient voltage and, in particular, the ballast quickly converts an input voltage into a higher voltage to initiate the arc. As such, a ballast controls the voltage through the lamps. A ballast also controls the amount of current that flows through the lamp. Without a ballast to control the current, a fluorescent lamp would quickly burn out.

Additionally, ballast for aircraft lighting systems have further requirements. For example, size and weight of a ballast is a concern for aircraft. The lighter and more compact a ballast is, the more cargo and other aircraft devices can be carried by or utilized on an aircraft. The ballast is also restricted to utilize specific input power and voltages and power specific types of lamps. The minimization or prevention of electromagnetic interference (EMI) from the lamp, wiring and ballast to other aircraft devices or components is also a concern.

In one application or instance, sometimes, a gap or break between the connection of the lamp or lamps to the ballast may occur. This gap may cause a spark or an external arcing condition. If the external arcing condition is not controlled, damage to the surrounding aircraft materials may result.

### SUMMARY OF THE INVENTION

The present invention provides systems and methods of controlling fluorescent lamps in aircraft lighting systems. In aspects of the present invention, a ballast for at least one fluorescent lamp is provided. The ballast comprises regulator supplying voltage to at least one fluorescent lamp and controller adjusting the supplied voltage based on the amount of voltage being supplied by the regulator and by regulating a current flowing in the regulator. In one aspect of the invention, the controller reduces the supplied voltage based on an occurrence of an arcing condition and the arcing condition is a specific amount of power being supplied by the regulator over a continuous period of time.

In one aspect of the invention, the regulator comprises converter and transistor coupled to the converter and allowing current to flow through the converter in a first condition. Also, the controller compares a first voltage and a second voltage and when the second voltage is lower than the first voltage the converter is in the first condition. Furthermore, in one aspect of the invention, the regulator prevents current from flowing through the converter in a second condition. Also, the controller compares a first voltage and a second voltage and when the second voltage is higher than the first voltage the converter is in the second condition. In further aspects of the invention, the regulator and controller are qualified for 115 volts or 230 volts usage for aircraft.

In another aspect of the invention, a ballast for fluorescent lamps is provided and comprises transformer, converter, flyback converter and control circuit. The transformer receives an input voltage and supplies the input voltage to the converter. The converter rectifies the input voltage and the flyback converter generates a voltage feedback. The control circuit receives the voltage feedback and causes the flyback converter to regulate the rectified input voltage based on the received voltage feedback and a reference voltage. In a further aspect of the invention, the ballast further comprises a lamp selection switch that internally switches between a single lamp configuration and a dual lamp configuration. In another aspect of the invention, the frequency converter comprises a reversing bridge and generates an output signal. The output signal has a frequency that corresponds or is similar to the frequency of the input voltage. In one aspect of the invention, the flyback converter generates a 400 Hertz low frequency signal.

In another aspect of the invention, a method to control at least one fluorescent lamp is provided. The method comprises supplying a voltage to at least one fluorescent lamp, detecting an amount of voltage supplied and regulating a current based on the detected amount of voltage. The current adjusts the amount of voltage supplied. In one aspect of the invention, the method regulates the current in order to maintain a constant power level to the at least one fluorescent lamp. In another aspect of the invention, the method further comprises switching between a single lamp configuration and a dual lamp configuration.

These and other aspects of the present invention will be more readily understood upon review of the accompanying drawings and following detailed description.

### BRIEF DESCRIPTION OF THE DRAWINGS

FIG. 1 illustrates a block diagram of an embodiment of an electronic ballast;

FIG. 2 illustrates a further block diagram of further embodiments of an electronic ballast;

FIG. 3 illustrates a semi-semantic diagram of an embodiment of a fly-back converter and a control circuit in an electronic ballast;

FIG. 4 illustrates a schematic diagram of an embodiment of an electronic ballast;

FIG. 5 illustrates a schematic diagram of another embodiment of an electronic ballast; and

FIG. 6 illustrates a block diagram of an embodiment of an electronic ballast coupled to fluorescent lamps.

### DETAILED DESCRIPTION

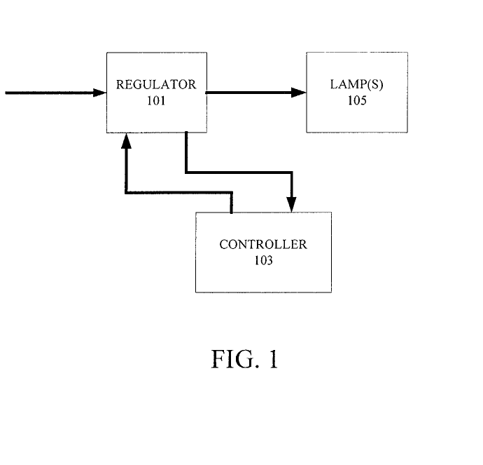

FIG. 1 illustrates a block diagram of one embodiment of an electronic ballast. The electronic ballast is coupled to one or more fluorescent lamps 105 and is configured to control the luminance of the lamps, e.g., dim the lamps or turn the lamps on or off. The electronic ballast includes a regulator 101 and a controller 103. The regulator 101 receives an input voltage and converts the input voltage to be utilized by the lamps. The controller is configured to command or otherwise direct the regulator to supply the converted voltage to the lamps. The controller also receives feedback from the regulator. Based on the feedback from the regulator, the controller directs the regulator to adjust the amount of voltage being supplied to the lamps.

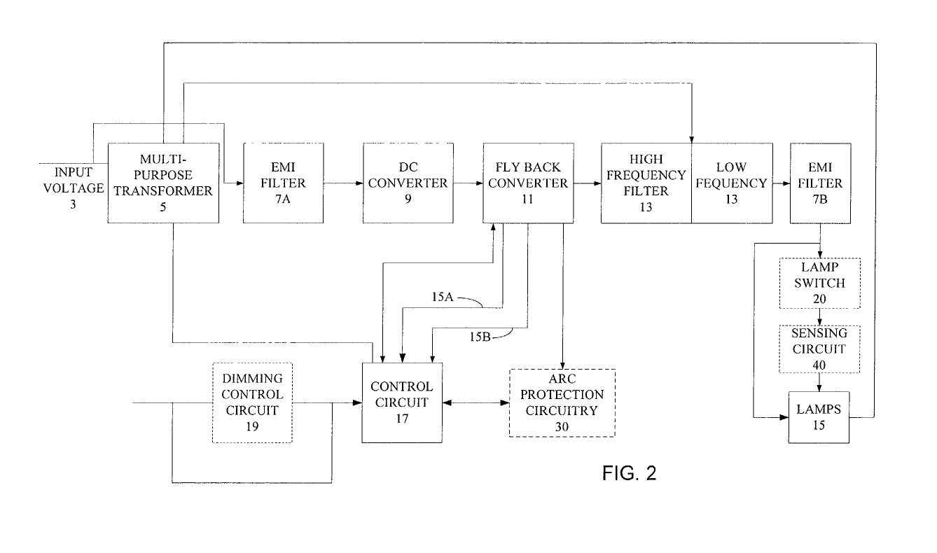

FIG. 2 illustrates a further block diagram of a further embodiment of an electronic ballast. An input voltage 3 is supplied to a multi-purpose transformer 5 and a first electromagnetic interference (EMI) filter 7A. The input voltage supplied is 115 VAC or 230 VAC with a 400 Hz frequency. The EMI filter 7A removes interference or noise on the input voltage. The input voltage is then supplied to a DC converter 9. The DC converter 9 full wave rectifies the input voltage and generates a full wave rectified output signal that is supplied to a fly-back converter 11.

The fly-back converter generates a current feedback 15A and a voltage feedback 15B that is supplied to a control circuit 17. The fly-back converter also supplies an output voltage, which is proportional to the full wave rectified voltage supplied by the DC converter, to a high frequency filter/low frequency converter 13. The high frequency filter/low frequency converter then filters an amplitude modulated look Hz signal from an envelope frequency of 800 Hz. The output signal from the high frequency filter/low frequency converter is then supplied to a second EMI filter 7B. The second EMI filter removes any interference on the output signal which is then used to power one or more fluorescent lamps 15. In one embodiment, the output signal is similar in frequency to the input voltage. The output signal, in the embodiment described, is a 400 Hz low frequency signal.

The control circuit 17, as mentioned above, receives a current feedback and a voltage feedback as inputs from the fly-back converter 11. The control circuit also receives control voltage from an external source. The control circuit converts the current feedback 15A to a voltage and compares the converted voltage to the control voltage. If the converted voltage does not correspond to the control voltage, the control circuit causes the fly-back converter to adjust in order to maintain a constant power level.

Likewise, the voltage feedback 15B is compared to the control voltage. If the voltage feedback does not correspond to the control voltage, the control circuit causes the fly-back converter to adjust in order to maintain a constant power level which in turn maintains a constant voltage at the output of the fly-back converter.

In one embodiment, a dimming control circuit 19 is coupled to the control circuit which adjusts the amount of control voltage supplied to the control circuit 17. The dimming circuit by adjusting the control voltage adjusts the power level maintained by the fly-back converter which thus ultimately maintains a constant power at the fluorescent lamp.

In one embodiment, a lamp selection switch 20 is provided and is coupled to the fluorescent lamps. The lamp selection switches allows connection of one or more lamps to the output of the second EMI filter 7B. The lamp selection switch allows the configuration from a single to a dual lamp and vice versa, an internal change rather than an external wiring change. As such, the lamp selection switch allows the ballast to be used in multiple applications where a single or dual ballast were previously utilized with external wiring that needed to be changed in order to switch from powering one lamp to one or more lamps and vice versa.

In one embodiment, an arc protection circuitry 30 is provided. The arc protection circuitry detects an open circuit condition by an increased feedback of voltage. The arc protection circuitry prevents voltage from being transferred to the lamps. In one embodiment, a circuit interrupter is tripped by the arc protection circuitry when the open circuit condition is detected.

In one embodiment, a high energy release (spark gap) for a minimum time will cause the arc protection circuitry to shutdown the ballast and thus turn off the fluorescent lamp. As such, the arc protection circuitry provides a safety arc shutdown for a broken fixture, improper lamp installation, a loose connector or a frayed wiring insulation in the ballast high output lines. The ballast is reset by turning external power “off” and then back “on” again. An interruption in power longer than a built-in circuit delay may also reset the ballast.

The arc protection circuitry, in one embodiment, at safety arc shut down illuminates a light emitting diode (LED). The LED remains lit until power is removed from the ballast. As such, a momentary power loss or transfer of power could reset the ballast and the light from the LED is extinguished. Thus, at least a 50 millisecond to 200 millisecond delay, in one embodiment, is utilized to account for momentary power interruptions. A circuit interrupter is also triggered at safety arc shut down. The interrupter would require a manual reset at the ballast in order for the ballast to be activated. The LED status remains unchanged with or without power being supplied, until the manual reset is activated.

In one embodiment, a momentary switch is provided externally on the ballast to provide for maintenance and other personnel to reset the power of the ballast. A power reset of the ballast is useful during installation and re-lamping of fixtures. In one embodiment, if the breaker, described above, is triggered, the external switch to reset the ballast will have no effect on the ballast.

A sensing circuit 40 is also provided in one embodiment in conjunction with or instead of the arc protection circuitry. The sensing circuit detects a faulty connection to the lamps. The sensing circuit also detects a prolonged increase in voltage being supplied to the lamp. The sensing circuit, upon detecting a faulty connection or an unwarranted increase in voltage, signals the detected condition via a light-emitting diode (LED) or switch and prevents voltage from being supplied to the lamps.

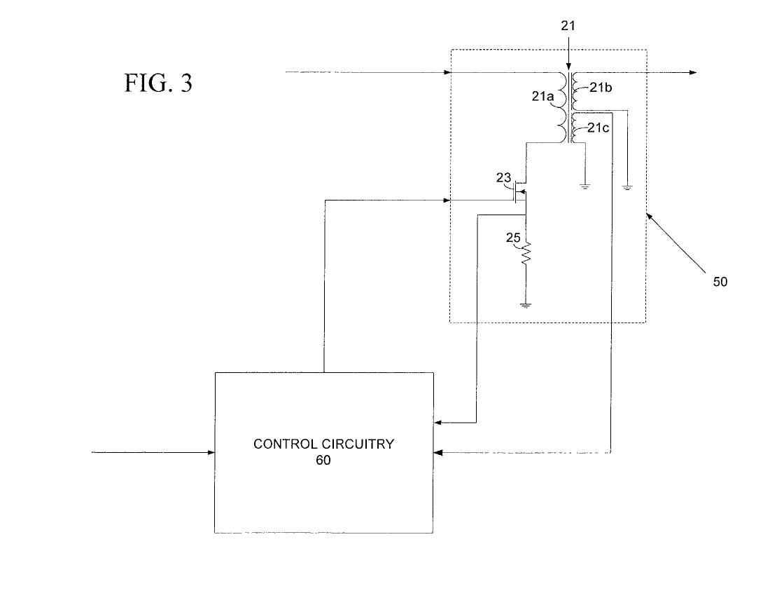

FIG. 3 illustrates a semi-semantic diagram of one embodiment of a fly-back converter and a control circuit in an electronic ballast. The fly-back converter 50 includes a transformer 21 and a transistor 23. The transformer is coupled to the input of the fly-back converter. The input of the fly-back converter is a full wave rectified voltage. Current flows through the transformer 21 which is supplied to the transistor 23 whose source is coupled to the transformer. The drain of the transistor is coupled to a resistor 25 which is coupled to ground. Additionally, the drain of the transistor is coupled to the control circuitry 60. The gate of the transistor is also coupled to the control circuitry. The transformer includes a primary winding 21a and a first and second secondary winding 21b, c. Both secondary windings are coupled to ground. The first secondary winding 21b is also coupled to a high frequency converter and ultimately to one or more fluorescent lamps (not shown). The second secondary winding 21c is coupled to the control circuitry.

The control circuitry is provided a reference voltage as an input. In the embodiment shown, the reference voltage is a 115 VAC 400 Hz voltage. The control circuitry rectifies the input reference voltage and compares the reference voltage to the voltage across resistor 25 of the fly-back converter. The voltage across the resistor is compared to the reference voltage to generate an output current. The output current is fed to the gate of the transistor 23. The amount of current supplied from the control circuitry is based on the comparison between the reference voltage and the voltage across resistor 25. In the embodiment described, as voltage increases across resistor 25 to be greater than the reference voltage, current output from the control circuitry is reduced. Conversely, as voltage across the resistor falls below the reference voltage, the amount of output current from the control circuitry is increased. Thus, voltage experienced at the gate of the transistor 23 is adjusted to maintain a constant current through the transistor and thus through the transformer. As a result, a constant power level is maintained at the input of the transformer. Likewise, constant power is maintained at the output of the transformer which is ultimately fed to the fluorescent lamps.

The control circuitry, in one embodiment, also compares the voltage from the second secondary winding 21c to the reference voltage. Similar to the comparison of the voltage across resistor 25 to the reference voltage, if the voltage from the secondary winding does not correspond to the reference voltage, the control circuitry adjusts the current output from the control circuitry. For example, if the voltage at the second secondary winding exceeds the reference voltage, the control circuitry reduces the current output. If the voltage at the secondary winding does not exceed the reference voltage, the control circuitry increases the current output. The current output fed to the transistor 23 adjusts the gate voltage which adjusts the gate to source voltage (V_{GS}) of the transistor to adjust the current through the transformer. Thus, power experienced at the input of the transformer remains constant which in turn keeps the output at the secondary windings constant.

As voltage increases at the first secondary winding 21b, so does the voltage at the second secondary winding 21c. The voltage of the second secondary winding which is fed to the control circuitry will not remain excessively high since the voltage from the second secondary winding will trigger the control circuitry to ultimately reduce the current through the primary winding of the transformer and thus causing voltage on the first secondary winding to decrease. Thus, constant power is maintained from the input to the output which is coupled to the fluorescent lamps, via the current feedback and the voltage feedback from a fly-back converter to a control circuitry.

In one instance, an external arcing condition may occur in which a gap opens in series with the fluorescent lamp and the electronic ballast. As such, an external arcing condition, which appears as a relatively high load resistance causes the voltage of the first secondary winding to increase and if left unchecked, the voltage will increase to an excessively high voltage causing damage to the lamps and generally creating an unsafe condition. However, after a short delay, the voltage at the first secondary winding is decreased and not permitted to increase up to an excessively high voltage. In this instance, the current through the transformer is reduced to reduce voltage of the first secondary winding via the interaction of the voltage feedback supplied by the second secondary winding, the control circuitry and the transistor, as described above. Thus, any excessively high voltage at the first secondary winding will not be sustained and thus an arc will be extinguished.

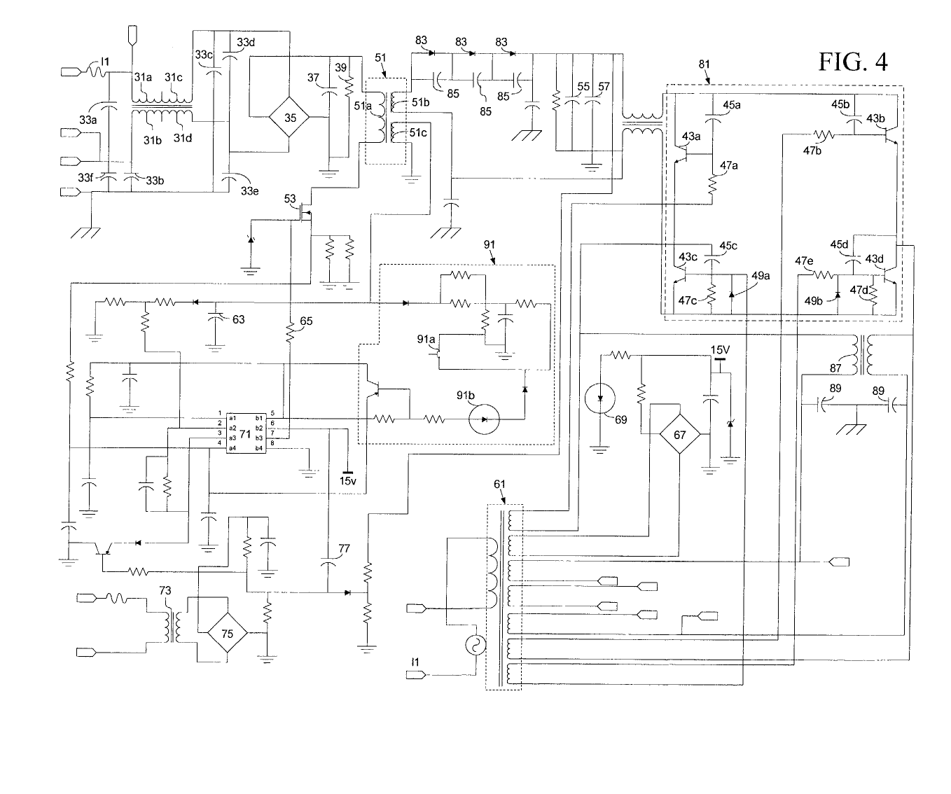

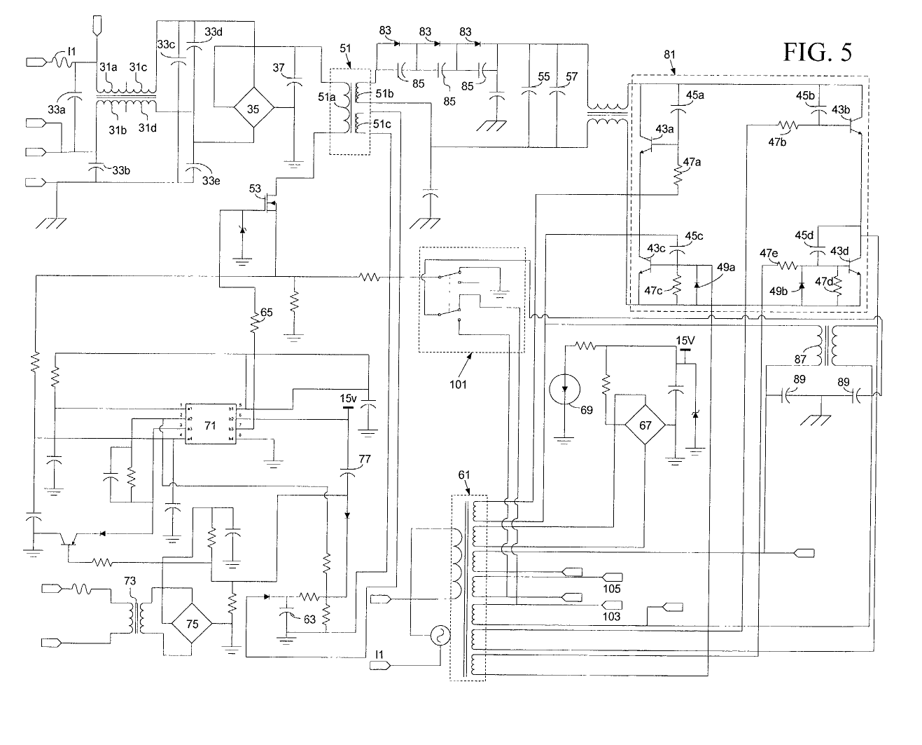

FIGS. 4-5 illustrate schematic diagrams of various embodiments of an electronic ballast of the present invention. In FIG. 4, input power I1 is provided to the electronic ballast. The input power, in one embodiment, is a standard aircraft power of 115 alternating current voltage (VAC) or 230 VAC at a frequency of 400 Hertz (Hz) plus or minus 20 Hz. In other various embodiments, various other voltages and frequencies are supplied to and utilized by the electronic ballast. The high frequency components of the input power is filtered by inductors 31a-d and capacitors 33a-f. As such, EMI from the ballast back onto power lines from which the input power came is reduced.

A diode bridge 35 is coupled to the inductors 31a-d and capacitors 33a-f and full-wave rectifies the voltage from the input power. Capacitor 37 is coupled to the diode bridge and the rectified voltage is applied to the capacitor. The capacitance of the capacitor is relatively small at the frequency of 400 Hz. As such, in the embodiment described, the waveform of the voltage across the capacitor is primarily a full-wave rectified voltage having a frequency of 400 Hz and having peaks of 330 volts with respect to the ground of the electronic ballast.

The diode bridge supplies the rectified voltage to a transformer 51. The resistor 39 limit in rush current from the input power and buffer the unfiltered and rectified input power to transformer 51. The transformer includes a primary winding 51a, a first secondary winding 51b and a second secondary winding 51c. The transformer 51 output from the first secondary winding is switched at 100K Hz and is contained in an envelope at 400 doubled 800 Hz half cycle rate. The output is also charged by the output current from the capacitor 55 and stores the charge on the capacitor at each 800 Hz half cycle. The second secondary winding of transformer 51c provides for a non-loading feedback monitoring of voltage, which after filtering, the capacitor 63 represents the voltage rise by the current into the storage capacitor 55. Thus, the transformer maintains circuit isolation while monitoring the circuit.

The input power is also applied to the primary windings of a transformer 61. The transformer has seven low voltage secondary windings. One of the secondary windings supplies power to a control integrated circuit 71. Three of the secondary windings supply power to the lamp filaments (not shown). The remaining secondary windings supply power to a reversing bridge and in particular to drive the transistors of the reversing bridge.

The reversing bridge includes transistors 43a-d, capacitors 45a-d, resistors 47a-e and diodes 49a, b. The reversing bridge converts the full-wave rectified voltage applied to capacitor 57 back to a sine wave voltage waveform. During one half cycle of the input voltage from the secondary windings of the transformer 61, the transistors 43a and 43d turn on and transistors 43b and 43c turn off. As such, positive voltage is applied on one side or an upper side of the capacitor 57 which is coupled one side of a lamp terminal. A negative voltage is also applied to the other or lower side of the capacitor 57 which is coupled to the opposite side of the lamp terminal.

Subsequently, the following half cycle of the input voltage from the secondary windings of the transformer 61, the transistors 43b and 43c turn on and transistors 43a and 43d turn off. As such, positive voltage is applied to the lower side of the capacitor 57 and a negative voltage is applied to the upper side of the capacitor 57. Thus, a full sine wave voltage is applied to the lamp terminals. Since the full wave rectified voltage is derived from the same 400 Hz input voltage as applied to the primary winding of the transformer 39, the waveform voltages are synchronized along with the full sine wave voltage waveform.

As the transistors 43a-d are operated either in saturation or in cutoff mode and all the switching occurs with low voltage being applied, the transistor have minimal loss and are relatively small. The resistors 47a-d coupled to the respective transistors 43a-d limit the base current through the respective transistors. Capacitors 45a-d attenuate any spikes that may appear on the collectors of the respective transistors. Diodes 47a and 47b allow transistors 43b and c to be driven from a common secondary winding of the transformer 61.

As such, a current-controlled waveform whose shape is similar to the full-wave rectified waveform on capacitor 37 and then synchronously reversing it to reconstruct an amplitude-controlled power-frequency sine-wave is provided. The synchronous reversal contributes to good waveform symmetry (i.e., low DC content), which is a positive factor in achieving long life in a fluorescent lamp. The combination of low power filament drive through a line-frequency power transformer with the reconstructed sine-wave provides constant voltage filament power independent of lamp current, and simplifies the control circuits and provides an inherently low EMI circuit. In addition, a high power factor is achieved without active power factor correction.

At maximum brightness, the current transferred through transformer 51 is primarily proportional to the instantaneous amplitude of the full-wave rectified line voltage. As a result, the input impedance is primarily resistive and thus a near-unity power factor occurs. As the brightness of the lamp is reduced, the current through the transformer tends to exhibit a flat-topped characteristic which reduces the apparent power factor.

As previously described, the full wave rectified voltage from the diode bridge is applied to the transformer 51. The transformer is coupled to a transistor 53. The transistor, in one embodiment, is a field effect transistor. The transistor is coupled to a control integrated circuit 71. In one embodiment, the control integrated circuit provides pulse width modulation control.

The current transferred through transformer 51 to capacitor 57 and ultimately to the lamps is proportional to the instantaneous voltage across capacitor 37. The voltage is limited by the control integrated circuit. In one embodiment, the voltage is limited to be no greater than a voltage that is proportional to a predetermined AC voltage, a control voltage, applied to the control integrated circuit. When the lamp is at maximum brightness, the transferred current is proportional to the instantaneous voltage across the capacitor 37 and has a waveform of a full-wave rectified 400 Hz sine-wave. When the lamp is at a lowered brightness setting, the amplitude of the current waveform is reduced and its peaks flatten. Under normal operating conditions, the voltage on the capacitor 57 is a full-wave rectified 400 Hz sine-wave similar to the voltage on the capacitor 37. Capacitor 37 and 57 have a low pass capacitance and as such filters out high frequency components of the voltage.

When the lamp is not conducting, e.g., before a strike voltage has been applied, no or negligible current flows from capacitor 57. As such, voltage across the capacitor rises rapidly. Through the secondary windings of the transformer 51, a voltage feedback is provided to the control integrated circuit. The control integrated circuit monitors the voltage feedback and allows the open circuit voltage across the capacitor 57 to rise enough to strike the lamp, i.e., provide a strike voltage. However, the control integrated circuit also prevents the voltage from rising excessively beyond the strike voltage and thus prevents damage to the ballast and the lamps.

In one embodiment, a sensor, such as an optical or hall effect type sensor is used to sense abnormal output to limit power. The control integrated circuit could also be by-passed by a sensing circuit control coupled directly to the transistor 53 and the sensor.

In one embodiment, a flyback regulator circuit comprises the transformer 51, transistor 53 and the control integrated circuit 71. When the lamps are operating under a normal steady state mode, e.g., providing maximum and less then maximum illumination, the flyback regulator is a current feedback mode. When the lamps are not operating, the flyback regulator is a voltage feedback mode.

The control integrated circuit, in one embodiment, operates or manipulates the current and voltage feedback modes of the flyback regulator. The control integrated circuit includes timing and comparator circuits. The control voltage is adjustable and, in one embodiment, is a 400 Hz sine-wave having an amplitude proportional to the desired brightness for the lamps. The desired maximum or full brightness is indicated by a 115 VAC. The voltage is applied to transformer 73. The secondary winding of the transformer is full-wave rectified by diode bridge 75 and filtered by capacitor 77 to provide a DC value that is proportional to the desired brightness. The DC voltage is applied to the control integrated circuit.

The control integrated circuit also meters current from the unfiltered rectified line into the energy storage capacitor 63. The voltage on the capacitor serves as the DC source which is modulated by a 400 Hz square wave to power the fluorescent lamp. Since the feedback is based on current into the storage capacitor 63, the effect is more of a constant power source than a constant current. As such, if the lamp voltage increases, the lamp current decreases, and vice versa.

In one embodiment, when a gap opens in series with the lamp, an external arc, which forms, appears as a relatively high resistance, nearly as high as the equivalent lamp resistance. As the load voltage increases, the maximum current decreases accordingly, quickly extinguishing the arc. With feedback from the lamp, a current sense resistor 65 is used to maintain the lamp current constant. In this case, as the arc forms, the output voltage rises to maintain the current. The added voltage is dropped across the arc resistance, dissipating a very significant amount of power in a very small volume.

Shutoff in the event of arcing depends on sensing the voltage across the load. Under normal conditions, the lamp voltage is about 400 volts peak-to-peak (Vpp). As a gap opens, the voltage rises, up to about 600 Vpp. Since this voltage level is also required to strike the fluorescent lamps, a slow delay is employed to distinguish between the normal strike time of a few tens of milliseconds to the extended time of an arc. The delay, in one embodiment, ranges from 0.5 to 1 second. In another embodiment, the delay is about 2 seconds.

An arc detection circuitry 91 is provided in which a fuse will trip 91a and/or a LED 91b will illuminate when the voltage experienced at the second secondary winding exceeds a predetermined reference level. In one embodiment, the predetermined reference level is a voltage level that approximately corresponds to a fraction of the voltage necessary to strike or ignite the fluorescent lamp. In one embodiment, the predetermined reference is approximately 6 volts. As such, the ballast provides arc shutdown and limits input to a 10% increase on input current during the arcing condition for a maximum time to shutdown of 2 seconds. The ballast also takes into account momentary power loss to allow for standard and abnormal aircraft power (interruptions) transfers. The arc detection circuitry also, in one embodiment, is provided to point out potential maintenance problems in addition to quench external arcs. If the arc detection circuitry trips, it may indicate a faulty fixture or a burned-out lamp that requires attention.

Various other components such as inductors, capacitors, transistors and transformers not specifically described act as filters to remove high frequency components out the voltage ultimately applied to the lamps. As such, these components reduce EMI from the ballast, lamp and wiring.

In FIG. 5, lamp switches 101 are shown to toggle between the selection of one or two fluorescent lamps. The electronic ballast, in the embodiment illustrated, is qualified for 230 volts operation and includes multiple EMI filters to prevent interference to other aircraft components. The lamp switch improves system efficiency by changing current limits. In particular, switch 101 provides a wiring change of pin 103 to pin 105 to complete the lamp strike circuit and thus power dual lamps in series. The ground in this dual configuration provides an increased current flow through transistor 53 and also provides a higher drive limit. The switch also provides a high efficiency for dual 40 watts lamps in both single and dual mode operation by allowing the current limit to be optimized by resistor 107. Likewise, the switch also provide power saving over a various range of lamps with various wattage. Thus, the universal design of the ballast provides efficient operation for single or dual lamp configurations with multiple lamp loads and a simple installation.

In other embodiments, sensing circuits are included with the electronic ballast. In one embodiment, a sensing circuit is coupled to the input to sense or detect changes in input current and/or input power. As input current and/or input power increases, the sensing circuit notifies the control circuit to adjust current through the fly-back converter. As such, as previously described in reference to FIG. 2, constant power is maintained at the input and output of the ballast. Likewise, in one embodiment, a sensing circuit is coupled to the output of the ballast to detect changes in the output current and/or the output power.

As changes occur in the output power and/or current, the sensing circuit notifies the control circuit which adjusts the current through the fly-back converter and thus constant power is maintained from the input to the output of the ballast. The sensing circuits detecting input current and/or power may be coupled to different locations from the input to the ballast to the input of the transformer directly or via one or more components. Sensing circuits for detecting the output current and/or power may be coupled at various locations of the ballast from the output of the transformer to the output of the ballast directly or via one or more components.

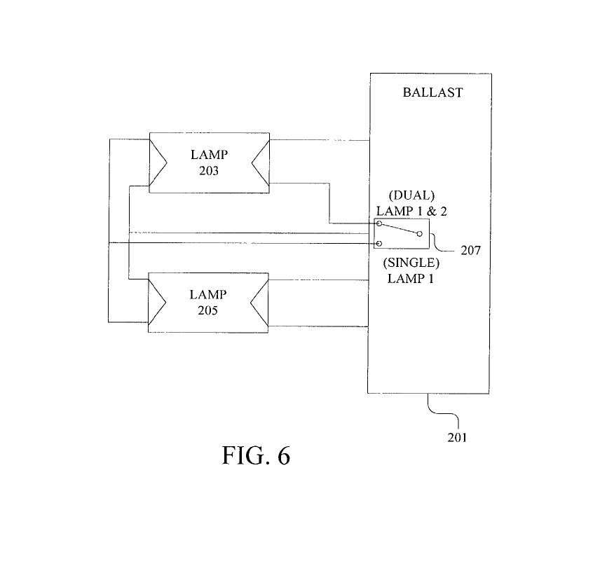

In FIG. 6, an electronic ballast 201 is coupled to two fluorescent lamps 203 and 205 connected in series. The electronic ballast comprises of all solid state components and thus runs cooler and consumes less power than conventional magnetic ballasts. In one embodiment, the lamps are F14T12, F15T12, F20T12, F30T12 or F40T12 designated lamps. A lamp selection switch 207 is activated to accommodate the two lamps. The electronic ballast, in one embodiment, is a 230 volt electronic ballast with low EMI and which is qualified for aircraft usage. The ballast includes internal high frequency switching for a smaller and lighter circuit and configurable to 400 Hz for low emission lamp output.

Accordingly, the present invention provides an electronic ballast for controlling fluorescent lamps. Specifically, in one embodiment, the electronic ballast is used to control fluorescent lamps used in aircraft. Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive.

1. A ballast for at least one fluorescent lamp, the ballast comprising:
regulator supplying voltage to at least one fluorescent lamp; and
controller adjusting the supplied voltage based on an amount of voltage being supplied by the regulator and by regulating a current flowing in the regulator.

2. The ballast of claim 1 wherein the controller reduces the supplied voltage based on an occurrence of an arcing condition.

3. The ballast of claim 2 wherein the arcing condition is a specific amount of power being supplied by the regulator over a continuous period of time.

4. The ballast of claim 2 wherein the controller detects the occurrence of the arcing condition.

5. The ballast of claim 1 wherein the regulator is configured to provide a feedback voltage to the controller.

6. The ballast of claim 1 wherein the controller monitors the supplied voltage from the regulator such that a constant power is maintained.

7. The ballast of claim 1 wherein the regulator comprises:
lines supplying voltage to the at least one fluorescent lamp; and
selection switch internally coupling the lines to power the at least one fluorescent lamp.

8. The ballast of claim 1 wherein the controller compares a first voltage and second voltage and prevents flow of the supplied voltage from the regulator when the second voltage is higher than the first voltage.

9. The ballast of claim 8 wherein the first voltage is a predetermined reference voltage and the second voltage is based on the supplied voltage from the regulator.

10. The ballast of claim 1 wherein the regulator comprises:
converter; and
transistor coupled to the converter and allowing current to flow through the converter in a first condition.

11. The ballast of claim 10 wherein the controller prevents current from flowing through the converter in a second condition.

12. The ballast of claim 10 wherein the controller regulates current through the transistor to allow current to flow through the converter.

13. The ballast of claim 11 wherein the controller regulates current through the transistor to prevent current to flow through the converter.

14. The ballast of claim 12 wherein the controller regulates the current through the transistor by regulating the gate to source voltage of the transistor.

15. The ballast of claim 10 wherein the controller compares a first voltage and second voltage and when the second voltage is lower than the first voltage the converter is in the first condition.

16. The ballast of claim 11 wherein the controller compares a first voltage and second voltage and when the second voltage is higher than the first voltage the converter is in the second condition.

17. The ballast of claim 15 wherein the first voltage is a predetermined reference voltage and the second voltage is based on a voltage feedback from the converter, the voltage feedback being based on the supplied voltage from the regulator.

18. The ballast of claim 16 wherein the first voltage is a predetermined reference voltage and the second voltage is based on a voltage feedback from the converter, the voltage feedback being based on the supplied voltage from the regulator.

19. The ballast of claim 1 wherein the regulator comprises filters to reduce electromagnetic interference.

20. The ballast of claim 1 wherein the regulator and controller are qualified for 230 volts usage for aircraft.

21. The ballast of claim 1 wherein the regulator and controller are qualified for 115 volts usage for aircraft.

22. The ballast of claim 1 wherein the regulator and controller are composed entirely of electronic components.

23. A ballast for fluorescent lamps, the ballast comprising:
transformer receiving a input voltage and supplying the input voltage to a converter;
converter rectifying the input voltage;
flyback converter generating a voltage feedback; and
control circuit receiving the voltage feedback and causing the flyback converter to regulate the rectified input voltage based on the received voltage feedback and a reference voltage.

24. The ballast of claim 23 further comprising filter preventing electromagnetic interference.

25. The ballast of claim 24 further comprising frequency converter converting frequency of the rectified voltage.

26. The ballast of claim 25 further comprising dimming control circuit adjusting the reference voltage.

27. The ballast of claim 23 further comprising lamp selection switch internally switching between a first lamp configuration and a dual lamp configuration.

28. The ballast of claim 23 further comprising sensing circuitry detecting a faulty connection to the fluorescent lamps.

29. The ballast of claim 23 further comprising an arc protection circuitry detecting an arcing condition.

30. The ballast of claim 29 wherein the flyback converter prevents flow of the rectified input voltage when the arcing condition is detected.

31. The ballast of claim 29 further comprising breaker tripping when the arcing condition is detected.

32. The ballast of claim 29 further comprising light emitting diode emitting light when the arcing condition is detected.

33. The ballast of claim 29 wherein the flyback converter prevents flow of the rectified input voltage when the arcing condition is detected and after a predetermined delay has passed.

34. The ballast of claim 23 wherein the control circuit monitors current through the flyback converter.

35. The ballast of claim 23 wherein the frequency converter comprises a reversing bridge including transistors, resistors, capacitors and diodes and only half of the transistor are on at the same time.

36. The ballast of claim 23 wherein the frequency converter generates a 400 Hertz frequency signal.

37. The ballast of claim 23 wherein the frequency converter generates an output signal with a similar frequency to the input voltage.

38. The ballast of claim 37 wherein the output signal is a 400 Hertz frequency signal.

39. The ballast of claim 37 wherein the output signal powers the at least one fluorescent lamps.

40. The ballast of claim 23 wherein the frequency converter generates an output signal having a frequency that corresponds to a frequency of the input voltage.

41. The ballast of claim 40 wherein the output signal has a frequency that is not greater than 400 Hertz.

42. A method to control at least one fluorescent lamp, the method comprising:
supplying a voltage to at least one fluorescent lamp;
detecting an amount of voltage supplied;
regulating a current based on the detected amount of voltage, the current adjusting the amount of voltage supplied.

43. The method of claim 42 wherein regulating the current is based on maintaining a constant power level to the at least one fluorescent lamp.

44. The method of claim 42 wherein regulating the current further comprises comparing a first voltage and a second voltage.

45. The method of claim 44 wherein regulating the current further comprises preventing the current from flowing when the second voltage is higher than the first voltage.

46. The method of claim 45 wherein the first voltage is a predetermined reference voltage and the second voltage is based on the detected amount of voltage.

47. The method of claim 42 further comprising switching -between a single lamp configuration and a dual lamp configuration.

48. The method of claim 45 further comprising internally coupling one fluorescent lamp to a ballast in the single lamp configuration.

49. The method of claim 48 further comprising internally coupling two fluorescent lamps in series to a ballast in the dual lamp configuration.
